(19) United States
(12) Patent Application Publication
(10) Pub. No.: US 2017/0086210 A1
(43) Pub. Date: Mar. 23, 2017

(54) Managing Inter-Radio Access Technology Procedure Concurrency

(71) Applicant: QUALCOMM Incorporated, San Diego, CA (US)

(72) Inventors: Anand Rajurkar, Hyderabad (IN); Parthasarathy Krishnamoorthy, San Diego, CA (US); Chih-Ping Hsu, San Diego, CA (US); Reza Shahidi, San Diego, CA (US); Raghavendra Shyam Anand, Chickballapur (IN)

(21) Appl. No.: 14/862,931

(22) Filed: Sep. 23, 2015

(51) Int. Cl. H04W 72/10; H04W 72/08; H04W 72/04

(52) U.S. Cl. CPC H04W 72/10; H04W 72/0446; H04W 72/085; H04W 88/06

(57) ABSTRACT

Embodiments include systems and methods for managing inter-radio access technology (IRAT) procedure concurrency between subscriptions on a multi-subscription multi-active communication device. A device processor may identify a higher-priority subscription and a lower-priority subscription on the multi-subscription multi-active communication device. The device processor may determine whether an IRAT procedure on the lower-priority subscription will overlap in time with an IRAT procedure on the higher-priority subscription. The device processor may calculate a deferral time period for the lower-priority subscription in response to determining that the IRAT procedure on the lower-priority subscription will overlap in time with the IRAT procedure on the higher-priority subscription. The device processor may defer performance of the lower-priority subscription IRAT procedure using the deferral time period in order to perform the IRAT procedure on the higher-priority subscription, and may perform the IRAT procedure on the lower-priority subscription after the deferral time period.

### BACKGROUND

Mobile communication devices having two or more subscriber identity modules (SIMs) can communicate with one or more wireless networks using multiple subscriptions (“multi-subscription” communication devices). Each SIM may be associated with a different service provider subscription. Mobile communication devices having multiple SIMs and two or more antennas may conduct two or more concurrent communication sessions with different networks (“multi-active” communication devices). Communication devices that support two or more concurrent communication devices using two or more subscriptions can be called “multi-subscription multi-active” communication devices.

Each SIM may support two or more radio access technologies (RATs), a capability called “multimode.” A multimode communication device may use an inter-RAT (IRAT) procedure to detect and switch to the strongest signal from a cell or base station of a communication network that uses any of the RATs supported by the multimode communication device. For example, a multimode communication device communicating over a first signal using a first RAT may detect that the first signal drops below a threshold signal level, and may scan for a second signal using a second RAT. Using the second RAT, the multimode communication device may detect that the second signal is above the signal level threshold, and may switch to communicating using the second signal and the second RAT. Current multi-subscription multi-active communication devices can support multimode on one subscription.

### SUMMARY

Various embodiments include methods of managing inter-radio access technology (IRAT) procedures for two or more subscriptions on multi-subscription multi-active communication devices. Various embodiments may include identifying a higher-priority subscription and a lower-priority subscription on the multi-subscription multi-active communication device, determining whether an IRAT procedure on the lower-priority subscription is scheduled to overlap in time with an IRAT procedure scheduled for the higher-priority subscription, calculating a deferral time period for the lower-priority subscription in response to determining that the IRAT procedure on the lower-priority subscription will overlap in time with the IRAT procedure on the higher-priority subscription, deferring performance of the IRAT procedure on the lower-priority subscription for the deferral time period, and performing the IRAT procedure on the lower-priority subscription after the deferral time period.

In some embodiments, identifying a higher-priority subscription and a lower-priority subscription on the multi-subscription multi-active communication device may include determining a data latency sensitivity of a first communication session on a first subscription, and assigning a priority to the first subscription based on the data latency sensitivity of the first communication session. Some embodiments may further include determining a data latency sensitivity of a second communication session on a second subscription, and assigning a priority to the second subscription based on the data latency sensitivity of the second communication session.

In some embodiments, identifying a higher-priority subscription and a lower-priority subscription on the multi-subscription multi-active communication device may include determining a data throughput of a first communication session on a first subscription, and assigning a priority to the first subscription based on the data throughput of the first communication session. Some embodiments may further include determining a data throughput of a second communication session on a second subscription, and assigning a priority to the second subscription based on the data throughput of the second communication session.

In some embodiments, determining whether an IRAT procedure on the lower-priority subscription will overlap in time with an IRAT procedure on the higher-priority subscription may include determining a timing of an IRAT procedure on the higher-priority subscription and determining a timing of an IRAT procedure on the lower-priority subscription in response to the IRAT procedures being triggered for both the higher-priority subscription and the lower-priority subscription, and determining whether the timing of the IRAT procedure on the lower-priority subscription will overlap in time with the timing of the IRAT procedure on the higher-priority subscription. Some embodiments may further include performing a first scheduled one of the IRAT procedure on the higher-priority subscription and the IRAT procedure on the lower-priority subscription in response to determining that the IRAT procedure on the lower-priority subscription will not overlap in time with the IRAT procedure the higher-priority subscription.

Some embodiments may further include performing an IRAT procedure on the higher-priority subscription during the deferral time period. In some embodiments, deferring performance of the lower-priority subscription IRAT procedure for the deferral time period may include performing the IRAT procedure on the higher-priority subscription, determining whether the IRAT procedure on the higher-priority subscription is complete, determining whether the deferral time period has elapsed in response to determining that the IRAT procedure on the higher-priority subscription is complete, and performing the IRAT procedure on the lower-priority subscription in response to determining that the deferral time period has elapsed.

Furthering embodiments may include a multi-subscription multi-active communication device having a processor configured to perform operations of the methods described above. Furthering embodiments may include a multi-subscription multi-active communication device having means for performing functions of the methods described above. Further embodiments may include non-transitory processor-readable storage media on which are stored processor-executable instructions configured to cause a processor of a multi-subscription multi-active communication device to perform operations of the methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of various embodiments, and not to limit various embodiments.

FIG. 1 is a component block diagram of a communication system suitable for use with various embodiments.

FIG. 2 is a component block diagram of a multi-subscription multi-active communication device according to various embodiments.

FIG. 3 is a process flow diagram illustrating a method for managing an inter-radio access technology (IRAT) procedure concurrency according to various embodiments.

FIG. 4 is a process flow diagram illustrating a method for managing an IRAT procedure concurrency according to various embodiments.

FIG. 5 is a component block diagram of a multi-subscription multi-active communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented in multi-subscription multi-active communication devices that enable management of IRAT procedure concurrency in a manner that avoids overlap of concurrently scheduled IRAT procedures of two or more subscriptions of the multi-subscription multi-active communication device without additional hardware, such as memory elements or processors. Managing IRAT procedure concurrency to avoid overlap of concurrently scheduled IRAT procedures may improve the performance of services using the two or more subscriptions.

The term “multi-subscription multi-active (MSMA) communication device” is used herein to refer to any one or all of cellular telephones, smartphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms that include a programmable processor, a memory, and two or more radio frequency (RF) resource configured to support communication using two or more subscriptions. Various embodiments may be particularly useful in any communication devices that can support multiple wireless wide area network subscriptions using a variety of radio access technologies.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a multi-subscription multi-active communication device and the multi-subscription multi-active communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

References to “first network,” “first subscription,” “second network,” and “second subscription” are arbitrary and are used to refer to two or more subscriptions/networks generally because at any given time either subscription/network may be in an active mode (on an active voice or data communication session) or a standby mode, and all subscriptions/networks may need to monitor for system information (e.g., for network system information block transmissions). For example, the multi-subscription multi-active communication device may conduct two (or more) concurrent communication sessions using two (or more) subscriptions. As another example, at one time the multi-subscription multi-active communication device may conduct an active communication session using a first subscription with a first network (and thus a “first subscription) while a second subscription with a second network is in a standby mode (and thus a “second” subscription). Later the second subscription may enter an active data call (becoming the “first” subscription) and the first subscription may enter the standby mode (becoming the “second” subscription). Also, references to “first” and “second” subscriptions and networks are not intended to imply that the embodiments are limited to two subscriptions sharing one RF resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

MSMA communication devices may be configured to support multimode operations that on two or more subscriptions using two or more RATs. The RATs may include, for example, Long Term Evolution (LTE), Global System for Mobility (GSM), Wideband Code Division Multiple Access (WCDMA), Single-Carrier Radio Transmission Technology (1×RTT), and other radio access technologies.

A multimode MSMA communication device may use an inter-RAT (IRAT) procedure to detect and switch to the strongest signal from a cell or base station of a communication network that uses any of the RATs supported by the multimode communication device. For example, a multimode MSMA communication device communicating over a first signal using a first RAT (e.g., LTE) may detect that the first signal drops below a threshold signal level, and may scan for a second signal using a second RAT (e.g., WCDMA). Based on signals received on the second RAT the multimode communication device may detect that the second signal is above the signal level threshold, and may switch to communicating using the second signal and the second RAT.

Performing an IRAT procedure for even a single subscription consumes a significant amount of the communication device's processing power, memory, and battery storage. Further, MSMA communication devices may encounter a situation in which an IRAT procedure is triggered on two or more subscriptions concurrently (i.e., overlapping in time). Thus managing the performance of IRAT procedures on MSMA communication devices can provide performance improvements. However, adding hardware to a communication device to manage IRAT concurrency may not be feasible because adding such hardware may increase power consumption unacceptably, as well as increase manufacturing costs of the communication device.

Various embodiments provide methods implemented by a processor in a multi-subscription multi-active communication device for managing IRAT procedure concurrency on the multi-subscription multi-active communication device to perform IRAT procedures on two or more subscriptions while providing sufficient data throughput for latency-sensitive applications, all without the addition of any physical hardware or other devices to the MSMA communication device.

In various embodiments, a processor of an MSMA communication device (a “device processor”) may determine a latency sensitivity of two active communication sessions, and may determine a priority of each of the active communication sessions. In some embodiments, the device processor may determine the communication session priorities based on latency sensitivities of each of the communication sessions. Some types of communication sessions may be more sensitive than other types of communication sessions to data delay, data error, packet loss, and other forms of data latency. For example, the performance of a voice communication session (e.g., Voice over Internet Protocol (VoIP), Voice over Long Term Evolution (VoLTE), and other types of voice communication session) may be easily degraded by delays in receiving data. As another example, the performance of a data communication session may be less sensitive to latency.

In some embodiments, the device processor may assign a higher priority to a communication session that is highly sensitive to data latency, and assign a lower priority to a communication session that is less sensitive to data latency. For example, the device processor may assign a higher priority to a voice communication session and a lower priority to a concurrent data communication session. In some embodiments, the device processor may determine the priority of each communication session based on a minimum performance threshold for each communication session (e.g., a certain minimum data rate, minimum throughput, maximum data error rate, or another threshold). In various embodiments such performance thresholds may be predefined (e.g., by a service provider, device manufacturer, or a user preference setting) for each type of communication (e.g., voice, data, media streaming, etc.). In some embodiments, the device processor may determine the priority of each communication session based on whether the latency sensitivity of each communication session is above or below the latency sensitivity threshold appropriate for the type of communication involved in the session.

In some embodiments, the device processor may assign the priorities based on a data throughput of each of the communication sessions. For example, a data throughput of a communication session may vary based on a radio access technology used, a modulation and coding scheme (MCS) assigned for the communication session, communication link conditions (e.g., RF interference, wireless communication link congestion, and similar communication link conditions), network congestion (e.g., backhaul congestion), and other factors that may affect a throughput of a communication session. In some embodiments, the device processor may assign a higher priority to a communication session with a higher data throughput, and may assign a lower priority to the communication session with a lower data throughput.

In some embodiments, in response to an IRAT procedure being triggered for the lower priority subscription, the device processor may determine whether there is an overlap in time between the IRAT procedure for the lower-priority subscription and an IRAT procedure for the higher-priority subscription. In some embodiments, an overlap may include a partial overlap in time between the respective IRAT procedures for the lower-priority subscription and the higher-priority subscription.

In some embodiments, an overlap may include scheduling the IRAT procedure for the lower-priority subscription within a threshold time prior to a scheduled IRAT procedure for the higher-priority subscription. In some embodiments, the device processor may determine the threshold time based on IRAT procedure performance schedules of the first RAT (e.g., on the first subscription) and the second RAT (e.g., on the second subscription).

In response to determining that there is an overlap between the lower-priority subscription IRAT procedure and the higher-priority IRAT procedure, the device processor may defer performing the IRAT procedure for the lower-priority subscription.

In some embodiments, the device processor may determine a deferral time period for deferring the IRAT procedure for the lower-latency sensitivity subscription. In some embodiments, the device processor may dynamically determine the deferral time period based on the RATs being used in the first subscription and the second subscription, and the RATs to be scanned in the IRAT procedure of the higher latency-sensitivity subscription. The device processor may then defer the IRAT procedure of the second subscription using the deferral time period.

At the end of the deferral time period, the device processor may perform the IRAT procedure for the lower latency-sensitivity subscription. In some cases, the device processor may perform an IRAT handover for the second subscription. Thus, the various embodiments enable the multi-subscription multi-active communication device to manage the performance of an IRAT procedure in two or more subscriptions without additional hardware, such as memory elements or processors.

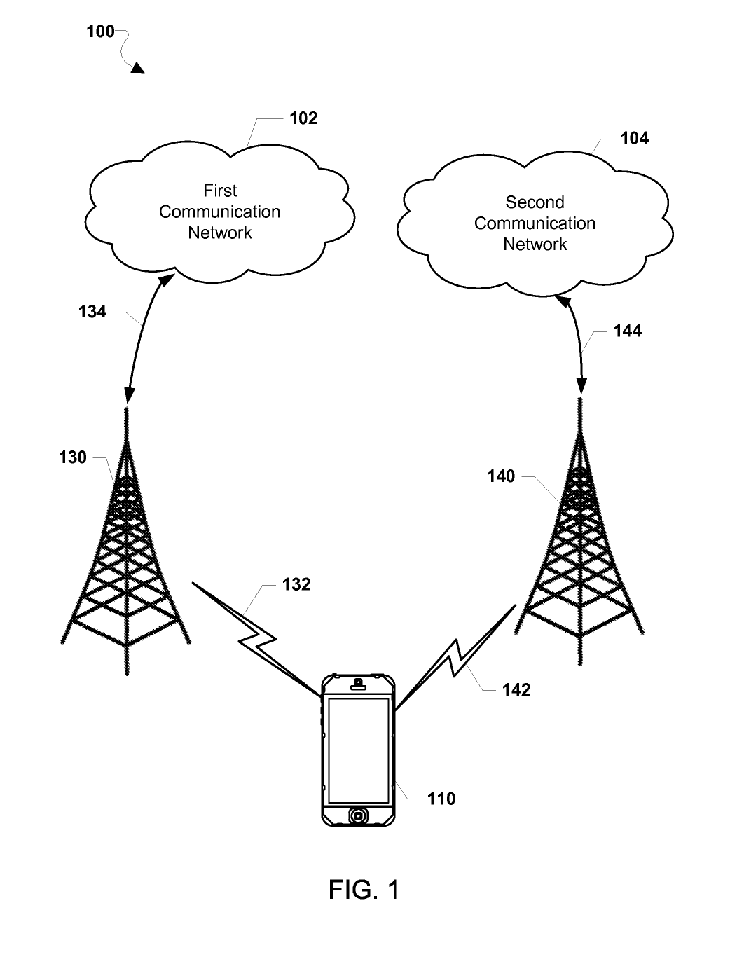

Various embodiments may be implemented within a variety of communication systems 100, such as systems that include at least two mobile communication networks, an example of which is illustrated in FIG. 1. A first communication network 102 and a second communication network 104 each may include a plurality of cellular base stations (e.g., a first base station 130 and a second base station 140). A multi-subscription multi-active communication device 110 may communicate with the first communication network 102 through a communication link 132 to the first base station 130. The multi-subscription multi-active communication device 110 may also communicate with the second communication network 104 through a communication link 142 to the second base station 140. The first base station 130 may communicate with the first communication network 102 over a wired or wireless communication link 134, and the second base station 140 may communicate with the second communication network 104 over a wired or wireless communication link 144. The communication links 134, 144 may include fiber optic backhaul links, microwave backhaul links, and other similar communication links.

Each of the communication networks 102 and 104 may support communications using one or more radio access technologies, and each of the communication links 132, 134, 142, 144 may include cellular connections that may be made through two-way wireless communication links using one or more RATs. Examples of RATs may include LTE, Worldwide Interoperability for Microwave Access (WiMAX), Code Division Multiple Access (CDMA), Time Division Multiple Access (TDMA), WCDMA, GSM, and other RATs. While the communication links 132, 134, 142, 144 are illustrated as single links, each of the communication links may include a plurality of frequencies or frequency bands, each of which may include a plurality of logical channels. Additionally, each of the communication links 132, 134, 142, 144 may utilize more than one RAT.

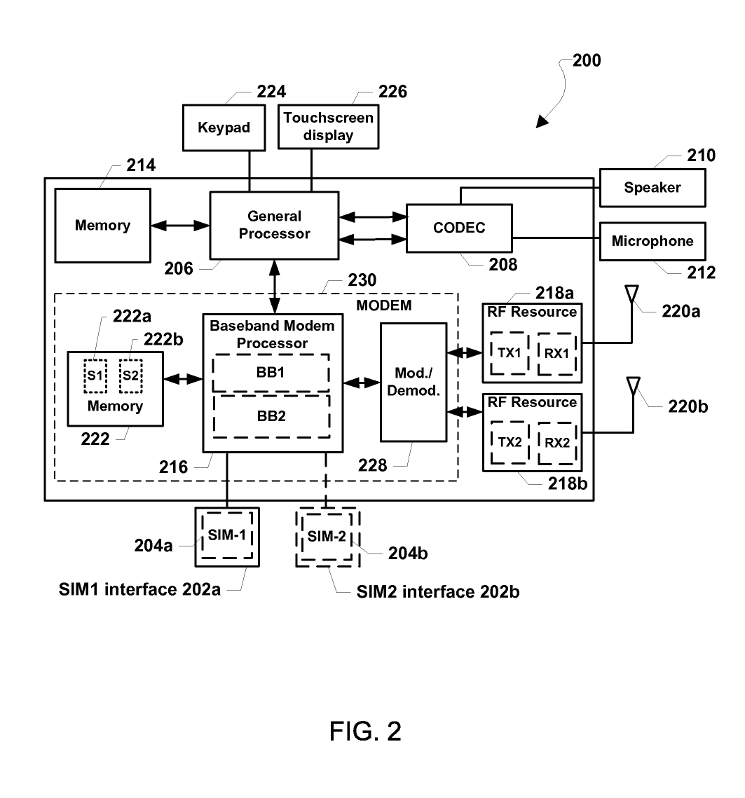

FIG. 2 is a component block diagram of an MSMA communication device 200 suitable for implementing various embodiments. With reference to FIGS. 1 and 2, in various embodiments, the MSMA communication device 200 may be similar to MSMA communication device 102. The MSMA communication device 200 may include a first SIM interface 202a, which may receive a first identity module SIM-1 204a that is associated with a first subscription. The MSMA communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The MSMA communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general-purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to one or more RF resources 218a, 218b for transmission. The modulator/demodulator 228 may also extract an information-bearing signal from a modulated carrier wave received from the one or more RF resources 218a, 218b, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack 51 222a and protocol stack S2 222b. The protocol stacks 51 222a, S2 222b generally include computer executable instructions to enable communication using a radio access protocol or communication protocol. Each protocol stack 51 222a, S2 222b typically includes network protocol layers structured hierarchically to provide networking capabilities. The modem 230 may include one or more of the protocol stacks 51 222a, S2 222b to enable communication using one or more RATs. The protocol stacks 51 222a, S2 222b may be associated with a SIM card (e.g., SIM-1 204a, SIM-2 204b) configured with a subscription. For example, the protocol stack 51 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the MSMA communication device 200 (e.g., SIM-1 204a, SIM-2 204b) may be coupled to the modem 230 and may be associated with or permitted to use an RF resource. The term “RF resource chain” may be used to refer to all of the circuitry used to send and receive RF signals, which may include the baseband modem processor 216 that performs baseband/modem functions for communicating with/controlling a RAT, one or more radio units including transmitter and receiver components that are shown as RF resources 218a, 218b (e.g., in FIG. 2), one or more of the wireless antennas 220a, 220b, and additional circuitry that may include one or more amplifiers and radios. The term “Rx chain” may be used to refer to a portion of an RF resource chain that may receive RF signals, and the term “Tx chain” may be used to refer to a portion of an RF resource that may transmit RF signals. In some embodiments, an RF resource may share a common baseband modem processor 216 (i.e., a single device that performs baseband/modem functions for all RATs on the MSMA communication device). In some embodiments, each RF resource may include the physically or logically separate baseband processors (e.g., BB1, BB2).

The RF resources 218a, 218b may include transceivers associated with one or more RATs and may perform transmit/receive functions for the MSMA communication device 200 on behalf of the respective RATs. The RF resources 218a, 218b may include separate transmit and receive circuitry. In some embodiments, the RF resource 218b may include only receive circuitry. The RF resources 218a, 218b may each be coupled to a wireless antenna (e.g., the first wireless antenna 220a and the second wireless antenna 220b). The RF resources 218a, 218b may also be coupled to the modem 230 (e.g., via the modulator/demodulator 228, the baseband modem processor 216, or another component).

In some embodiments, the general-purpose processor 206, memory 214, baseband processor(s) 216, and the RF resources 218a, 218b may be included in the MSMA communication device 200 as a system-on-chip. In some embodiments, the first and second SIMs 204a, 204b, and corresponding interfaces 202a, 202b, may be external to the system-on-chip. Further, various input and output devices may be coupled to components on the system-on-chip, such as interfaces or controllers. Example user input components suitable for use in the MSMA communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive a selection of a contact from a contact list or receive a telephone number. As another example, the request to initiate the outgoing call may be in the form of a voice command received via the microphone 212. Interfaces may be provided between the various software modules and functions in the MSMA communication device 200 to enable communication between them.

Functioning together, the two SIMs 204a, 204b, the baseband processor(s) 216, RF resources 218a, 218b and the antennas 220a, 220b may enable communications on two or more RATs. For example, one SIM, baseband processor, and RF resource may be configured to support two different RATs. In other embodiments, more RATs may be supported on the MSMA communication device 200 by adding more SIM cards, SIM interfaces, RF resources, and antennas for connecting to additional mobile networks.

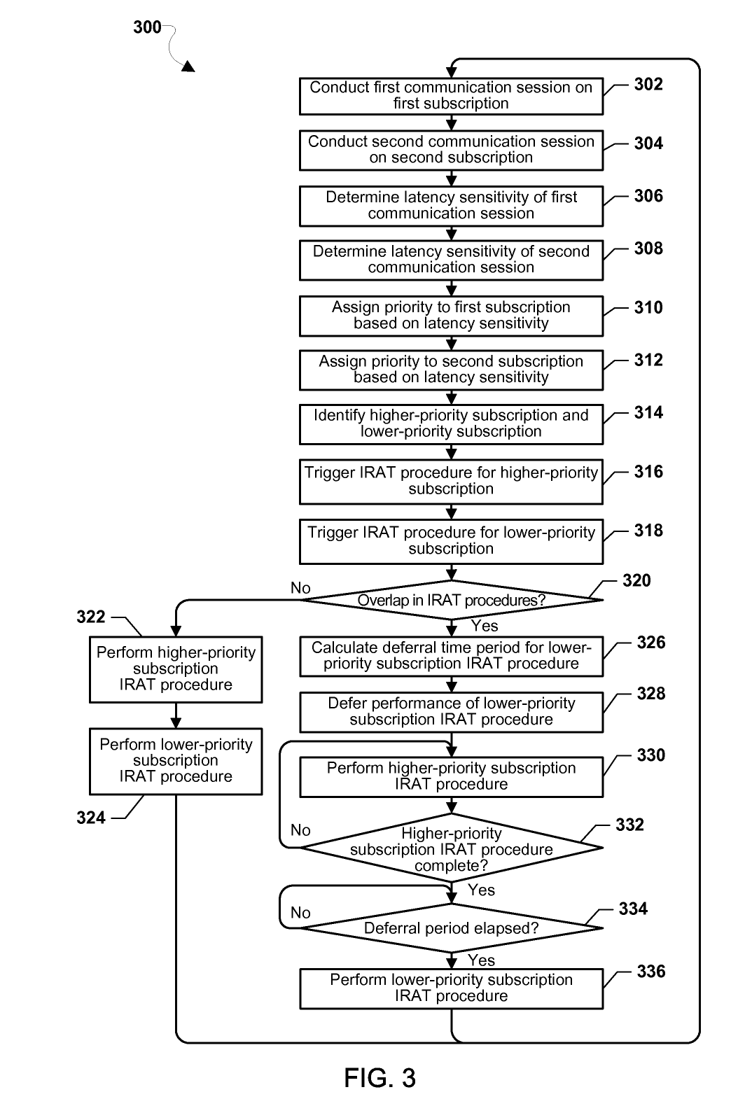

FIG. 3 illustrates a method 300 for managing IRAT procedure concurrency in a multi-subscription multi-active communication device according to some embodiments. With reference to FIGS. 1-3, the method 300 may be implemented by a device processor (e.g., the general-purpose processor 206, the baseband processor 216, a separate controller, and/or the like) of a multi-subscription multi-active communication device (e.g., the multi-subscription multi-active communication device 102, 200).

In block 302, the MSMA communication device may conduct a first communication session on a first subscription. In block 304, the MSMA communication device may conduct a second communication session on a second subscription.

In block 306, the device processor may determine a latency sensitivity of the first communication session. In block 308, the device processor may determine a latency sensitivity of the second communication session. Some types of communication sessions may be more sensitive than other types of communication sessions to data delay, data error, packet loss, and other forms of data latency. For example, the performance of a voice communication session (e.g., Voice over Internet Protocol (VoIP), Voice over Long Term Evolution (VoLTE), and other types of voice communication session) may be easily degraded by latency, especially compared to a data communication session.

In block 310, the device processor may assign a priority to the first subscription based on the determined latency sensitivity of the first communication session, and in block 312, the device processor may assign a priority to the second subscription based on the determined latency sensitivity of the second communication session. In some embodiments, the device processor may assign a higher priority to a subscription having a communication session that is sensitive to data latency, and assign a lower priority to a subscription having a communication session that is less sensitive data latency. For example, the device processor may assign a higher priority to a subscription conducting a voice communication session and a lower priority to a subscription conducting a data communication session.

In some embodiments, the device processor may determine the priority of each subscription in blocks 310 and 312 based on a minimum performance threshold for each communication session (e.g., a certain minimum data rate, minimum throughput, maximum data error rate, or another threshold). In some embodiments, the device processor may determine the priority of each subscription based on whether the latency sensitivity of each communication session is above or below a threshold latency sensitivity. In various embodiments, such performance thresholds and/or data latency tolerance thresholds may be predefined and stored in memory, such as by a service provider, by a device manufacturer, and/or by a user as a user preference setting.

In block 314, the device processor may identify a higher-priority subscription and a lower-priority subscription based on the determined data latency sensitivities (or performance requirements) of the first communication session on the second communication session.

In block 316, the device processor may trigger (i.e., determine to perform) an IRAT procedure for the higher-priority subscription. In block 318, the device processor may trigger an IRAT procedure for the lower-priority subscription. In some embodiments, the device processor may make the determination to perform each IRAT procedure based on a signal level of a signal used by each subscription. The signal level may include a signal strength (e.g., a Received Signal Strength Indicator (RSSI) or a Reference Signal Received Power (RSRP)), a signal quality (e.g., a Reference Signal Received Quality (RSRQ) or a Channel Quality Indicator (CQI)), a signal power (e.g., energy per chip over power density (Ec/No)), or another indication of signal level. In some embodiments, the device processor may determine that each IRAT procedure should be performed when the signal level drops below a signal level threshold.

In various embodiments, triggering an IRAT procedure may include determining a timing of when to perform the IRAT procedure. For example, when the device processor determines perform the IRAT procedure for the higher-priority subscription (or for the lower-priority subscription), the device processor may also determine the timing of when to perform the IRAT procedure.

In some embodiments, the timing of each IRAT procedure may also include a duration of each IRAT procedure. The device processor may determine the timing (and/or duration) of each IRAT procedure based on the RAT being used on the subscription, the RATs to be scanned during the IRAT procedure, and a signal strength trend of the signal being used by the subscription.

In determination block 320, the device processor may determine whether the IRAT procedure for the lower-priority subscription will overlap in time with the IRAT procedure for the higher-priority subscription. In some embodiments, an overlap may include a partial overlap in time between the IRAT procedures for the lower-priority subscription and the higher-priority subscription. The overlap may include scheduling the IRAT procedure for the lower-priority subscription within a threshold time prior to a scheduled IRAT procedure for the higher-priority subscription. For example, the processor may determine that the IRAT procedures will overlap when the IRAT procedure for the lower-priority subscription is scheduled too close to the beginning of the IRAT procedure for the higher-priority subscription to ensure that the high-priority subscription IRAT procedure will be performed reliably.

In some embodiments, the device processor may determine the threshold time based on the determined timing for performing each IRAT procedure that may be dictated by the first RAT (e.g., of the first subscription) and the second RAT (e.g., of the second subscription). In some embodiments, the threshold time may include a window of time during which the device processor is not permitted to schedule the IRAT procedure for the lower-priority subscription. For example, the window of time may include a time period prior to the scheduled beginning of the IRAT procedure for the higher-priority subscription, and the device processor may determine that the IRAT procedure for the lower-priority subscription is scheduled to begin too close in time to the beginning of the IRAT procedure for the higher-priority subscription.

In response to determining that there will be no overlap in time between the IRAT procedures for the lower-priority subscription and higher-priority subscription (i.e., determination block 320=“No”), the device processor may perform the IRAT procedure for the higher-priority subscription in block 322, and perform the IRAT procedure for the lower-priority subscription in block 324. The device processor may continue to conduct the first communication session on the first subscription in block 302, and to conduct the second communication session on the second subscription in block 304.

In response to determining that the IRAT procedures for the lower-priority subscription and higher-priority subscription will overlap (i.e., determination block 320=“Yes”), the device processor may calculate a deferral time period for the IRAT procedure of the lower-priority subscription in block 326. In some embodiments, the device processor may dynamically determine the deferral time period for the IRAT procedure of the lower-priority subscription based on the RATs being used in the higher-priority subscription and the lower-priority subscription, and the RATs to be scanned in the IRAT procedure of the higher-priority subscription. For example, the deferral time period for the IRAT procedure of the lower-priority subscription may be set long enough to enable completion the IRAT procedure of the higher-priority subscription based on an estimate of time required to complete that IRAT procedure in view of the RAT currently used in the higher-priority subscription and the RATs that will be scanned during the IRAT procedure.

In block 328, the device processor may defer the IRAT procedure of the lower-priority subscription using the deferral time period. In block 330, the device processor may perform the IRAT procedure of the higher-priority subscription.

In determination block 332, the device processor may determine whether the IRAT procedure for the higher-priority subscription is complete. In response to determining that the higher-priority subscription IRAT procedure is not complete (i.e., determination block 332=“No”), the device processor may continue to perform the higher-priority subscription IRAT procedure in block 330.

In response to determining that the higher-priority subscription IRAT procedure is complete (i.e., determination block 332=“Yes”), the device processor may determine whether the deferral time period has elapsed in determination block 334. In response to determining that the deferral time period has not elapsed (i.e., determination block 334=“No”), the device processor may continue to monitor the deferral time period in determination block 334.

In response to determining that the deferral time period has elapsed (i.e., determination block 334=“Yes”), the device processor may perform the IRAT procedure of the lower-priority subscription in block 336. In other embodiments, the device processor may perform the IRAT procedure of the lower-priority subscription in response to determining that the higher-priority IRAT procedure is complete (i.e., without waiting for the deferral period to elapse).

In some embodiments, the MSMA communication device may include common software, and may include a common resource manager module. The common software/resource manager may control the performance of IRAT procedures for the higher-priority subscription and for the lower-priority subscription. In some embodiments, the common software/resource manager may determine when the higher-priority subscription IRAT procedures complete in determination block 332. In some embodiments, the common software/resource manager may determine when the deferral time period has elapsed in determination block 334. In such embodiments, the common software/resource manager may initiate the lower-priority subscription IRAT procedure in block 336 upon determining that the deferral time period has elapsed.

The device processor may repeat the operations of the method 300 so long as the first communication session on the first subscription and the second communication session on the second subscription are conducted concurrently (blocks 302 and 304).

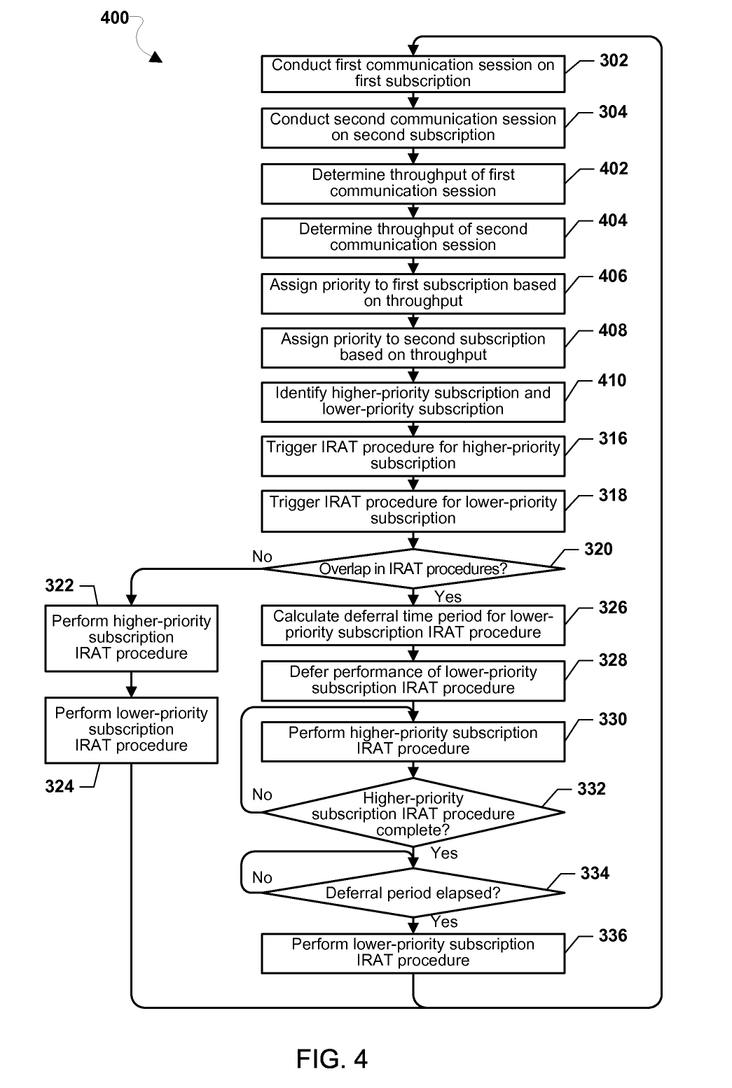

FIG. 4 illustrates a method 400 for managing IRAT procedure concurrency in a multi-subscription multi-active communication device according to some embodiments. With reference to FIGS. 1-4, the method 400 may be implemented by a device processor (e.g., the general-purpose processor 206, the baseband processor 216, a separate controller, and/or the like) of an MSMA communication device (e.g., the MSMA communication device 102, 200). In blocks 302-336, the device processor may perform operations of like numbered blocks of the method 300.

In block 402, the device processor may determine a throughput of the first communication session. In block 404, the device processor may determine a throughput of the second communication session. Each throughput may include a determination of successful delivery of data from each communication network to the MSMA communication device. The device processor may determine a throughput of each communication session based on a variety of factors that may affect communication session throughput. Such factors may include, for example, the RAT used in each communication session, a modulation and coding scheme (MCS) assigned for each communication session, communication link conditions (e.g., RF interference, wireless communication link congestion, and similar communication link conditions), and network congestion (e.g., backhaul congestion).

In block 406, the device processor may assign a priority to the first subscription based on the data throughput of the first communication session. In block 408, the device processor may assign a priority to the second subscription based on the data throughput of the second communication session. In some embodiments, the device processor may assign a higher priority to a subscription conducting a communication session that has a higher data throughput, and the device processor may assign a lower priority to a subscription conducting a communication session that has a lower data throughput.

In some embodiments, each subscription may use the same RAT (e.g., LTE, WCDMA, or another RAT). In some embodiments, each subscription may use a different RAT. Effects of a higher throughput include faster data reception and/or transmission, which may facilitate faster scanning, such as of other RATs, frequency bands, channels, and the like. A subscription with higher throughput may complete an IRAT procedure more quickly. Thus, in some embodiments, the device processor may assign a higher priority to a subscription having a communication session with a higher throughput, and may assign a lower priority to a subscription having a communication session with a lower throughput.

In block 410, the device processor may identify a higher-priority subscription and a lower-priority subscription based on the determined data throughputs of the first and second communication sessions.

Using the subscription priorities identified in block 410, the device processor may continue with the operations in blocks 316 through 336 of the method 300 as described. The device processor may repeat the operations of the method 400 so long as the first communication session on the first subscription and the second communication session on the second subscription are conducted concurrently (blocks 302 and 304).

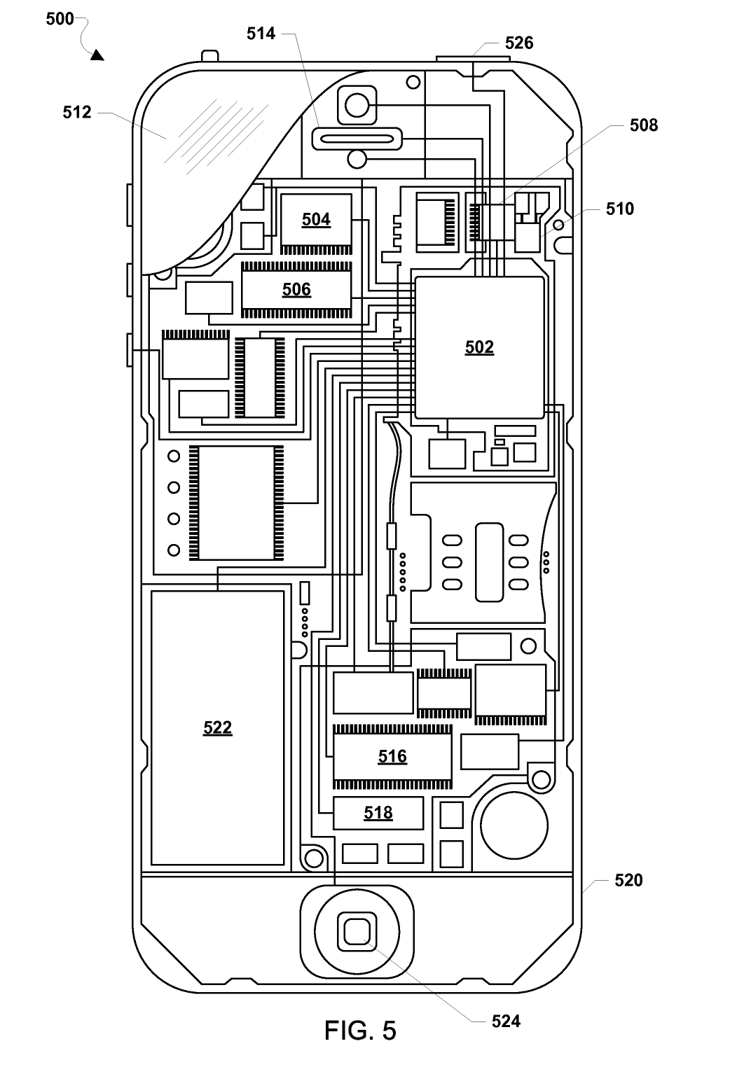

Various embodiments (including, but not limited to, embodiments described with reference to FIGS. 1-4) may be implemented in any of a variety of multi-subscription multi-active communication devices, an example of which (e.g., multi-subscription multi-active communication device 500) is illustrated in FIG. 5. With reference to FIGS. 1-5, in various embodiments, the multi-subscription multi-active communication device 500 (which may correspond, for example, to the multi-subscription multi-active communication devices 110 and 200 in FIGS. 1 and 2) may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecure and/or unencrypted memory, or any combination thereof The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the multi-subscription multi-active communication device 500 need not have touch screen capability.

The multi-subscription multi-active communication device 500 may have two or more radio signal transceivers 508 (e.g., Peanut, Bluetooth, ZigBee, Wi-Fi, RF radio) and antennae 510, for sending and receiving communications, coupled to each other and/or to the processor 502. The transceivers 508 and antennae 510 may be used with the above-mentioned circuitry to implement the various wireless transmission protocol stacks and interfaces. The multi-subscription multi-active communication device 500 may include one or more cellular network wireless modem chip(s) 516 coupled to the processor and antennae 510 that enables communication via two or more cellular networks via two or more radio access technologies.

The multi-subscription multi-active communication device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The multi-subscription multi-active communication device 500 may also include speakers 514 for providing audio outputs. The multi-subscription multi-active communication device 500 may also include a housing 520, constructed of a plastic, metal, or a combination of materials, for containing all or some of the components discussed herein. The multi-subscription multi-active communication device 500 may include a power source 522 coupled to the processor 502, such as a disposable or rechargeable battery. The rechargeable battery may also be coupled to the peripheral device connection port to receive a charging current from a source external to the multi-subscription multi-active communication device 500. The multi-subscription multi-active communication device 500 may also include a physical button 524 for receiving user inputs. The multi-subscription multi-active communication device 500 may also include a power button 526 for turning the multi-subscription multi-active communication device 500 on and off.

The processor 502 may be any programmable microprocessor, microcomputer or multiple processor chip or chips that can be configured by software instructions (applications) to perform a variety of functions, including the functions of various embodiments described below. In some multi-subscription multi-active communication devices, multiple processors 502 may be provided, such as one processor dedicated to wireless communication functions and one processor dedicated to running other applications. Typically, software applications may be stored in the internal memory 506 before they are accessed and loaded into the processor 502. The processor 502 may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 300 may be substituted for or combined with one or more operations of the method 400, and vice versa.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume operation when the process returns to execution on the processor. This operational state data may include the process's address space, stack space, virtual address space, register set image (e.g., program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavyweight process that includes multiple lightweight processes or threads. Lightweight processes or threads are processes that share all or portions of context (e.g., address space, stack, permissions and/or access restrictions, etc.) with other processes or threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of various embodiments.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the spirit or scope of the embodiments. Thus, various embodiments are not intended to be limited to the embodiments shown herein but are to be accorded the widest scope consistent with the following claims and the principles and novel features disclosed herein.

What is claimed is:

1. A method of managing inter-radio access technology (IRAT) procedures for two or more subscriptions on a multi-subscription multi-active communication device, comprising:
identifying a higher-priority subscription and a lower-priority subscription on the multi-subscription multi-active communication device;
determining whether an IRAT procedure on the lower-priority subscription is scheduled to overlap in time with an IRAT procedure scheduled for the higher-priority subscription;
calculating a deferral time period for the lower-priority subscription in response to determining that the IRAT procedure on the lower-priority subscription will overlap in time with the IRAT procedure on the higher-priority subscription;
deferring performance of the IRAT procedure on the lower-priority subscription for the deferral time period; and
performing the IRAT procedure on the lower-priority subscription after the deferral time period.

2. The method of claim 1, wherein identifying a higher-priority subscription and a lower-priority subscription on the multi-subscription multi-active communication device comprises:
determining a data latency sensitivity of a first communication session on the first subscription; and
assigning a priority to the first subscription based on the data latency sensitivity of the first communication session.

3. The method of claim 2, wherein identifying a higher-priority subscription and a lower-priority subscription on the multi-subscription multi-active communication device further comprises:
determining a data latency sensitivity of a second communication session on the second subscription; and
assigning a priority to the second subscription based on the data latency sensitivity of the second communication session.

4. The method of claim 1, wherein identifying a higher-priority subscription and a lower-priority subscription on the multi-subscription multi-active communication device comprises:
determining a data throughput of a first communication session on the first subscription; and
assigning a priority to the first subscription based on the data throughput of the first communication session.

5. The method of claim 4, wherein identifying a higher-priority subscription and a lower-priority subscription on the multi-subscription multi-active communication device further comprises:
determining a data throughput of a second communication session on the second subscription; and
assigning a priority to the second subscription based on the data throughput of the second communication session.

6. The method of claim 1, wherein determining whether an IRAT procedure on the lower-priority subscription will overlap in time with an IRAT procedure on the higher-priority subscription comprises:
determining a timing of the IRAT procedure on the higher-priority subscription and determining a timing of the IRAT procedure on the lower-priority subscription in response to IRAT procedures being triggered for both the higher-priority subscription and the lower-priority subscription; and
determining whether the timing of the IRAT procedure on the lower-priority subscription will overlap in time with the timing of the IRAT procedure on the higher-priority subscription.

7. The method of claim 6, further comprising:
performing a first scheduled one of the IRAT procedure on the higher-priority subscription and the IRAT procedure on the lower-priority subscription in response to determining that the IRAT procedure on the lower-priority subscription will not overlap in time with the IRAT procedure the higher-priority subscription.

8. The method of claim 1, further comprising:
performing the IRAT procedure on the higher-priority subscription during the deferral time period.

9. The method of claim 1, wherein deferring performance of the IRAT procedure on the lower-priority subscription for the deferral time period comprises:
performing the IRAT procedure on the higher-priority subscription;
determining whether the IRAT procedure on the higher-priority subscription is complete;
determining whether the deferral time period has elapsed in response to determining that the IRAT procedure on the higher-priority subscription is complete; and
performing the IRAT procedure on the lower-priority subscription in response to determining that the deferral time period has elapsed.

10. A multi-subscription multi-active communication device, comprising:
a memory;
at least two radio frequency resources; and
a processor coupled to the memory and the at least two radio frequency resources, and configured to:
identify a higher-priority subscription and a lower-priority subscription on the multi-subscription multi-active communication device;
determine whether an inter-radio access technology (IRAT) procedure on the lower-priority subscription is scheduled to overlap in time with an IRAT procedure scheduled for the higher-priority subscription;
calculate a deferral time period for the lower-priority subscription in response to determining that the IRAT procedure on the lower-priority subscription will overlap in time with the IRAT procedure on the higher-priority subscription;
defer performance of the IRAT procedure on the lower-priority subscription for the deferral time period; and
perform the IRAT procedure on the lower-priority subscription after the deferral time period.

11. The multi-subscription multi-active communication device of claim 10, wherein the processor is further configured with processor-executable instructions to identify a higher-priority subscription and a lower-priority subscription on the multi-subscription multi-active communication device by:
determining a data latency sensitivity of a first communication session on the first subscription; and
assigning a priority to the first subscription based on the data latency sensitivity of the first communication session.

12. The multi-subscription multi-active communication device of claim 11, wherein the processor is further configured with processor-executable instructions to identify a higher-priority subscription and a lower-priority subscription on the multi-subscription multi-active communication device by:
determining a data latency sensitivity of a second communication session on a second subscription; and
assigning a priority to the second subscription based on the data latency sensitivity of the second communication session.

13. The multi-subscription multi-active communication device of claim 10, wherein the processor is further configured with processor-executable instructions to identify a higher-priority subscription and a lower-priority subscription on the multi-subscription multi-active communication device by:
determining a data throughput of a first communication session on the first subscription; and
assigning a priority to the first subscription based on the data throughput of the first communication session.

14. The multi-subscription multi-active communication device of claim 13, wherein the processor is further configured with processor-executable instructions to identify a higher-priority subscription and a lower-priority subscription on the multi-subscription multi-active communication device by:
determining a data throughput of a second communication session on a second subscription; and
assigning a priority to the second subscription based on the data throughput of the second communication session.

15. The multi-subscription multi-active communication device of claim 10, wherein the processor is further configured with processor-executable instructions to determine whether an IRAT procedure on the lower-priority subscription will overlap in time with an IRAT procedure on the higher-priority subscription by:
determining a timing of the IRAT procedure on the higher-priority subscription and determining a timing of the IRAT procedure on the lower-priority subscription in response to IRAT procedures being triggered for both the higher-priority subscription and the lower-priority subscription; and
determining whether the timing of the IRAT procedure on the lower-priority subscription will overlap in time with the timing of the IRAT procedure on the higher-priority subscription.

16. The multi-subscription multi-active communication device of claim 15, wherein the processor is further configured with processor-executable instructions to:
perform a first scheduled one of the IRAT procedure on the higher-priority subscription and the IRAT procedure on the lower-priority subscription in response to determining that the IRAT procedure on the lower-priority subscription will not overlap in time with the IRAT procedure the higher-priority subscription.

17. The multi-subscription multi-active communication device of claim 10, wherein the processor is further configured with processor-executable instructions to:
perform the IRAT procedure on the higher-priority subscription during the deferral time period.

18. The multi-subscription multi-active communication device of claim 10, wherein the processor is further configured with processor-executable instructions to defer performance of the IRAT procedure on the lower-priority subscription for the deferral time period by:
performing the IRAT procedure on the higher-priority subscription;
determining whether the IRAT procedure on the higher-priority subscription is complete;
determining whether the deferral time period has elapsed in response to determining that the IRAT procedure on the higher-priority subscription is complete; and
performing the IRAT procedure on the lower-priority subscription in response to determining that the deferral time period has elapsed.

19. A multi-subscription multi-active communication device, comprising:
means for identifying a higher-priority subscription and a lower-priority subscription on the multi-subscription multi-active communication device;
means for determining whether an inter-radio access technology (IRAT) procedure on the lower-priority subscription is scheduled to overlap in time with an IRAT procedure scheduled for the higher-priority subscription;
means for calculating a deferral time period for the lower-priority subscription in response to determining that the IRAT procedure on the lower-priority subscription will overlap in time with the IRAT procedure on the higher-priority subscription;
means for deferring performance of the IRAT procedure on the lower-priority subscription for the deferral time period; and
means for performing the IRAT procedure on the lower-priority subscription after the deferral time period.

20. A non-transitory processor-readable medium having stored thereon processor-executable instructions configured to cause a processor of a multi-subscription multi-active communication device to perform operations comprising:
identifying a higher-priority subscription and a lower-priority subscription on the multi-subscription multi-active communication device;
determining whether an inter-radio access technology (IRAT) procedure on the lower-priority subscription is scheduled to overlap in time with an IRAT procedure scheduled for the higher-priority subscription;
calculating a deferral time period for the lower-priority subscription in response to determining that the IRAT procedure on the lower-priority subscription will overlap in time with the IRAT procedure on the higher-priority subscription;
deferring performance of the IRAT procedure on the lower-priority subscription for the deferral time period; and
performing the IRAT procedure on the lower-priority subscription after the deferral time period.

21. The non-transitory processor-readable medium of claim 20, wherein the stored executable instructions are configured to cause the processor of the multi-subscription multi-active communication device to perform operations such that identifying a higher-priority subscription and a lower-priority subscription on the multi-subscription multi-active communication device comprises:
determining a data latency sensitivity of a first communication session on the first subscription; and
assigning a priority to the first subscription based on the data latency sensitivity of the first communication session.

22. The non-transitory processor-readable medium of claim 21, wherein the stored executable instructions are configured to cause the processor of the multi-subscription multi-active communication device to perform operations such that identifying a higher-priority subscription and a lower-priority subscription on the multi-subscription multi-active communication device further comprises:
determining a data latency sensitivity of a second communication session on the second subscription; and
assigning a priority to the second subscription based on the data latency sensitivity of the second communication session.

23. The non-transitory processor-readable medium of claim 20, wherein the stored executable instructions are configured to cause the processor of the multi-subscription multi-active communication device to perform operations such that identifying a higher-priority subscription and a lower-priority subscription on the multi-subscription multi-active communication device comprises:
determining a data throughput of a first communication session on the first subscription; and
assigning a priority to the first subscription based on the data throughput of the first communication session.

24. The non-transitory processor-readable medium of claim 23, wherein the stored executable instructions are configured to cause the processor of the multi-subscription multi-active communication device to perform operations such that identifying a higher-priority subscription and a lower-priority subscription on the multi-subscription multi-active communication device further comprises:
determining a data throughput of a second communication session on the second subscription; and
assigning a priority to the second subscription based on the data throughput of the second communication session.

25. The non-transitory processor-readable medium of claim 20, wherein the stored executable instructions are configured to cause the processor of the multi-subscription multi-active communication device to perform operations such that determining whether an IRAT procedure on the lower-priority subscription will overlap in time with an IRAT procedure on the higher-priority subscription comprises:
determining a timing of the IRAT procedure on the higher-priority subscription and determining a timing of the IRAT procedure on the lower-priority subscription in response to IRAT procedures being triggered for both the higher-priority subscription and the lower-priority subscription; and
determining whether the timing of the IRAT procedure on the lower-priority subscription will overlap in time with the timing of the IRAT procedure on the higher-priority subscription.

26. The non-transitory processor-readable medium of claim 25, wherein the stored executable instructions are configured to cause the processor of the multi-subscription multi-active communication device to perform operations further comprising:
performing a first scheduled one of the IRAT procedure on the higher-priority subscription and the IRAT procedure on the lower-priority subscription in response to determining that the IRAT procedure on the lower-priority subscription will not overlap in time with the IRAT procedure the higher-priority subscription.

27. The non-transitory processor-readable medium of claim 20, wherein the stored executable instructions are configured to cause the processor of the multi-subscription multi-active communication device to perform operations further comprising:
performing the IRAT procedure on the higher-priority subscription during the deferral time period.

28. The non-transitory processor-readable medium of claim 20, wherein the stored executable instructions are configured to cause the processor of the multi-subscription multi-active communication device to perform operations such that deferring performance of the IRAT procedure on the lower-priority subscription for the deferral time period comprises:
performing the IRAT procedure on the higher-priority subscription;
determining whether the IRAT procedure on the higher-priority subscription is complete;
determining whether the deferral time period has elapsed in response to determining that the IRAT procedure on the higher-priority subscription is complete; and
performing the IRAT procedure on the lower-priority subscription in response to determining that the deferral time period has elapsed.
